(19) United States
(12) Patent Application Publication
(10) Pub. No.: US 2013/0016433 A1
(43) Pub. Date: Jan. 17, 2013

(54) Zoom Lens and Imaging Device

(71) Applicants: Yuichi Ozaki, Hachioji-shi (JP); Atsushi Yamashita, Sagamihara-shi (JP)

(72) Inventors: Yuichi Ozaki, Hachioji-shi (JP); Atsushi Yamashita, Sagamihara-shi (JP)

(73) Assignee: Konica Minolta Advanced Layers, Inc., Hachioji-shi, Tokyo (JP)

(21) Appl. No.: 13/509,764

(22) PCT Filed: Nov. 8, 2010
(86) PCT No.: PCT/JP2010/069798

§ 371 Date: May 14, 2012

(30) Foreign Application Priority Data
Nov. 17, 2009 (JP) 2009-261615

(51) Int. Cl. G02B 15/14

(52) U.S. Cl. 359/676

(57) ABSTRACT

Provided is a zoom lens including a first lens group having negative refractive power, a second lens group having positive refractive power, a third lens group having negative refractive power, and a fourth lens group having positive refractive power. The first lens group contains a reflective optical element that bends the light path. In order from the object side, the second lens group comprises a positive 2p1 lens, a negative 2n lens, and a positive 2p2 lens. The third lens group comprises a single negative lens. Letting n2n be the index of refraction of the 2n lens, n2p2 be the index of refraction of the 2p2 lens, ν2p2 be the Abbe number of the 2p2 lens, and ν2n be the Abbe number of the 2n lens, 0.30<n2n−n2p2<0.50 and 30<ν2p2−ν2n<60.

### TECHNICAL FIELD

The present invention relates to a zoom lens, containing four groups of lens groups, to carry out variable magnification by changing the distance between the lens groups and an imaging device provided with the zoom lens.

### BACKGROUND

Over recent years, with enhanced performance and miniaturization of imaging devices employing a solid-state imaging element such as a CCD (Charged Coupled Device) type image sensor or a CMOS (Complementary Metal Oxide Semiconductor) type image sensor, mobile phones and mobile information terminals provided with an imaging device are becoming popular. In these devices, since cost and size limitation is extremely severe, imaging devices provided with a solid-state imaging element which is smaller in the number of pixels and size than conventional digital still cameras and an imaging device provided with a single-focus optical system containing about 1-4 plastic lenses are being generally used. However, also in imaging devices mounted in mobile terminals, enhanced pixel resolution and enhanced performance are rapidly in progress, and thereby there are being demanded downsized and wide-angle variable modification optical systems, capable of being mounted in mobile phones, which enable to respond to high resolution imaging elements and to image an object distant from the photographer, as well as being capable of capturing an image in the case where the distance from an object cannot be extended as shown in indoor imaging.

In thin-type mobile information terminals, bending optical systems to allow the optical axis to bend at 90 degrees using a reflective optical element such as a prism are commonly used, and patent publications disclose variable magnification optical systems in which in a variable magnification optical system having 4 components of a negative-positive-negative-positive arrangement, the above reflective optical element is used as a first lens group for size reduction in the thickness direction (refer to Patent Documents 1 and 2).

### PRIOR ART DOCUMENTS

### Patent Documents

Patent Document 1: Unexamined Japanese Patent Application Publication No. 2007-93955
Patent Document 2: Unexamined Japanese Patent Application Publication No. 2006-284790

### BRIEF DESCRIPTION OF THE INVENTION

### Problems to be Solved by the Invention

Over recent years, to downsize the total imaging device, there are being developed solid-state imaging elements in which the compatibility between miniaturization and enhanced pixel resolution is realized by reducing the pixel pitch. As the pixel pitch is reduced, the amount of light entering one pixel is also decreased. Further, since high frequency components in the vicinity of the diffraction limit also need to be resolved, in imaging lenses, miniaturization and enhanced performance are being expected and also high-speed optical systems with further smaller F-number are being demanded.

However, in a variable magnification optical system as described in Patent Documents 1 and 2, the F-number in the telescopic end is relatively increased, and further while thickness is reduced using a variable magnification optical system, the total optical system length is large, whereby miniaturization is not sufficient from the viewpoint of the unit volume.

In view of such problems, the present invention was completed, and an object thereof is to provide a zoom lens, while being smaller than the conventional type, has small F-number and well-corrected aberrations and an imaging device provided with the zoom lens.

### Means to Solve the Problems

The above object is achieved by the following invention.

1. A zoom lens comprising, in order from an object side thereof a first lens group having negative refractive power; a second lens group having positive refractive power; a third lens group having negative refractive power; and a fourth lens group having positive refractive power,
wherein the zoom lens carries out variable magnification by changing distances between the lens groups,

wherein a distance between the first lens group and the second lens group decreases by a variable magnification ranging from a wide-angle end to a telescopic end,
wherein the first lens group contains a reflective optical element functioning to bend a light path by reflecting a light beam,
wherein the second lens group contains a positive 2 μl lens, a negative 2n lens, and a positive 2p2 lens in order from the object side,

wherein the third lens group contains a single negative lens, and

wherein zoom lens satisfies the following conditional expressions:

0.30<n2n−n2p2<0.50 (1)

30<ν2p2−ν2n<60 (2)

n2n: the refractive index of the 2n lens

n2p2: the refractive index of the 2p2 lens

ν2p2: the Abbe number of the 2p2 lens

ν2n: the Abbe number of the 2n lens

The fundamental configuration of the present invention to obtain a zoom lens, which is small and has well-corrected aberrations, contains, in order from the object side, a first lens group having negative refractive power and containing a reflective optical element functioning to bend the light path by reflecting a light beam, a second lens group having positive refractive power and containing 3 lenses, a third lens group having negative refractive power and containing a single lens, and a fourth lens group having positive refractive power.

When the first lens group is allowed to have a negative configuration, a light beam incident from the object side with large angle can be rapidly reduced, resulting in the advantage of size reduction of the front lens diameter. Further, when a reflective optical element is provided in the first lens group, the dimension of the depth direction of an imaging device can be reduced.

Further, in the present zoom lens, the composite power of the first lens group and the second lens group is always positive, and then variable magnification ranging from the wide-angle end to the telescopic end reduces the distance between the first lens group and the second lens group. Therefore, in the wide-angle end, the distance between the first lens group and the second lens group is separated to a maximum extent in variable magnification. In addition, the second lens group has positive refractive index and thereby the power arrangement of the first lens group and the second lens group results in a retrofocus arrangement. Accordingly, while the total length of the zoom lens is decreased, relatively large back focal length can be ensured, and thereby a space to arrange an optical low-pass filter or an infrared cut filter between the zoom lens surface on the most image side and the solid-state imaging element can be ensured.

On the other hand, since variable magnification ranging from the wide-angle end to the telescopic end reduces the distance between the first lens group and the second lens group, both lens groups can be considered a single lens group having positive power. In addition, the third lens group has negative refractive power and thereby the power arrangement of the composite positive refractive power of the first lens group and the second lens group and the negative refractive power of the third lens group becomes “positive-negative,” resulting in a telephoto arrangement. Therefore, in the present zoom lens, relatively large focal length is ensured and at the same time, the total optical length can be controlled.

Further, the third lens group is allowed to be a single lens and thereby the total third lens group can be prevented from becoming large in size. Thereby, a space for variable magnification can be ensured and cost reduction can be realized. Additionally, the weight of the total third lens group can be reduced and thereby during variable magnification, the load of an actuator can be suppressed.

Further, the fourth lens group is allowed to have positive refractive power and thereby the main light beam incident angle (the angle created by a main light beam and the optical axis) of a light flux focused in the peripheral portion of the imaging plane of the solid-state imaging element can be controlled to a small extent, whereby so-called telecentric characteristics can be ensured.

Further, the second lens group contains, in order from the object side, a positive 2 μl lens, a negative 2n lens, and a positive 2p2 lens. A 2 μl lens having positive refractive power is arranged on the most object side and thereby incident light having been diffused by the negative power of the first lens group is efficiently converged and then spherical aberration can be effectively corrected.

Furthermore, when with enhanced pixel resolution of a solid-state imaging element, a further high-speed zoom lens is demanded, with respect to spherical aberration generated by reducing F-number, a 2n lens having negative refractive power and a 2p2 lens having positive refractive power are arranged to produce a combination of a negative lens and a positive lens and thereby spherical aberration generated by F-number reduction can be effectively corrected and further chromatic aberration and coma aberration can be effectively corrected.

Conditional Expression (1) specifies the difference in refractive index between the 2n lens and the 2p2 lens. When the lower limit of Conditional Expression (1) is exceeded, an arrangement of a negative lens having large refractive index and a positive lens having low refractive index is made and thereby spherical aberration and coma aberration which cannot have been sufficiently corrected using the 2 μl lens can be effectively corrected. On the other hand, under the condition of less than the upper limit, a configuration employing an easily-available glass material can be made.

Further, the following conditional expression is preferably satisfied.

0.32<n2n−n2p2<0.45

Conditional Expression (2) specifies the difference in Abbe number between the 2p2 lens and the 2n lens. When the lower limit of Conditional Expression (2) is exceeded, a combination of a negative lens featuring large dispersion and a positive lens featuring small dispersion is made and thereby chromatic aberration can be effectively corrected. On the other hand, under the condition of less than the upper limit, a configuration employing an easily-available glass material can be made.

Further, the following conditional expression is preferably satisfied.

35<ν2p2−ν2n<55

2. The zoom lens described in item 1, wherein the first lens group contains a cemented lens having negative refractive power containing a negative 1n lens and a positive 1p lens on a most image side and the zoom lens satisfies the following conditional expressions.

1.5<|f1b/fT|<4.0 (3)

30<ν1n−ν1p<50 (4)

f1b: the composite focal length of a cemented lens on the most image side of the first lens group

fT: the focal length of the total system in the telescopic end

ν1n: the Abbe number of the 1n lens

ν1p: the Abbe number of the 1p lens

Since variable magnification ranging from the wide-angle end to the telescopic end reduces the distance between the first lens group and the second lens group, a light flux passing through the first lens group gradually increases in size. Thereby, spherical aberration and axial chromatic aberration generated in the first lens group increase. Therefor, a cemented lens having negative refractive power containing a negative 1n lens and a positive 1p lens is arranged on the most image side of the first lens group and thereby spherical aberration and axial cinematic aberration generated on the telescopic side can be efficiently corrected.

Conditional Expression (3) specifies the ratio of the composite focal length of a cemented lens of the first lens group to the focal length of the total system. Under the condition of less than the upper limit of Conditional Expression (3), the cemented lens has appropriate negative refractive power and then spherical aberration generated on the telescopic side can be efficiently collected. On the other hand, when the lower limit is exceeded, aberration occurrence due to an increase in the refractive power of the lens can be prevented.

Further, the following conditional expression is more preferably satisfied.

2.0<|f1b/fT|<3.0

Conditional Expression (4) specifies the difference in Abbe number between the 1p lens and the 1n lens. When the lower limit of Conditional Expression (4) is exceeded, a combination of a negative lens featuring large dispersion and a positive lens featuring small dispersion is made and thereby chromatic aberration on the telescopic side can be effectively corrected. On the other hand, under the condition of less than the upper limit, the correction insufficiency of chromatic aberration due to an increase in the distance between the first lens group and the second lens group on the wide-angle side can be prevented

3. The zoom lens described in item 1 or 2, wherein the second lens group has a cemented lens containing the 2n lens and the 2p2 lens and the zoom lens satisfies the following conditional expressions.

1.6<(r12n+r22n)/(r12n−r22n)<3.0 (5)

−0.8<(r12p2+r22/p2)/(r12p2−r22p2)<−0.4 (6)

r12n: the paraxial curvature radius of the object side of the 2n lens

r22n: the paraxial curvature radius of the image side of the 2n lens

r12p2: the paraxial curvature radius of the object side of the 2p2 lens

r22p2: the paraxial curvature radius of the image side of the 2p2 lens

Since a light flux passing through each lens constituting the second lens group is large and then the effect on spherical aberration and coma aberration is relatively large, the effect on aberration due to a production error becomes larger than in other lens groups. Therefor, when a 2n lens and a 2p2 lens are allowed to form a cemented lens, part elements can be reduced and further the position accuracy between the lenses can be enhanced, and thereby the effect of the production error can be suppressed, resulting in improved productivity. Further, since a tablet of a negative lens and a positive lens is produced, spherical aberration and chromatic aberration can be efficiently corrected.

Conditional Expression (5) specifies the shaping factor of a 2n lens. When the lower limit of Conditional Expression (5) is exceeded, the 2n lens has a strong meniscus shape and then the diffusion action of the joint surface is increased, and thereby spherical aberration which cannot have been sufficiently corrected can be efficiently corrected. On the other hand, under the condition of less than the upper limit, occurrence of high-dimensional aberration such as core flare due to an increase in the curvature of the joint surface can be prevented.

Conditional Expression (6) specifies the shaping factor of a 2p2 lens. Under the condition of less than the upper limit of Conditional Expression (6), the principal point position of the 2p2 lens is shifted to the object side and thereby the principal point distance from the 2 μl lens is decreased, whereby the effect of the refractive power of the 2p2 lens is increased in the cemented lens. Therefor, a positive refractive power is shared by the 2 μl lens and the 2p2 lens and thereby the refractive power of each lens can be reduced to prevent occurrence of each aberration. On the other hand, when the lower limit is exceeded, occurrence of high-dimensional aberration such as core flare due to an increase in the curvature radius of the joint surface can be prevented.

4. The zoom lens described in any one of items 1-3, wherein the zoom lens satisfies the following conditional expression.

3.0<f2n2p21f2p1<10.0 (7)

f2n2p2: the composite focal length of the 2n lens and the 2p2 lens

f2 p1: the focal length of the 2 μl lens

Conditional Expression (7) specifies the ratio of the composite focal length of the 2n lens and the 2p2 lens to the focal length of the 2 μl lens. A composite lens of a 2 μl lens, and a 2n lens and a 2p2 lens has a “positive-positive” configuration. When the lower limit of Conditional Expression (7) is exceeded, the principal point position of the second lens group is shifted to the object side and thereby the composite positive refractive power of the first lens group and the second lens group is increased in the telescopic end, resulting in size reduction of a zoom lens. Under the condition of less than the upper limit, aberration occurrence due to an excessive increase in the refractive power of the 2 μl lens can be prevented.

5. The Zoom lens described in any one of items 1-4, wherein the first lens group contains, on the most object side, a lens having negative refractive power and a meniscus shape whose convex surface faces the object side.

When on the most object side of the first lens group, a meniscus lens whose convex surface faces the object side is arranged, the incident angle of a light beam is reduced and thereby occurrence of aberration such as image plane curvature or coma aberration can be prevented,

6. The zoom lens described in any one of items 1-5, wherein the first lens group has a lens of negative refractive power on the most object side and the zoom lens satisfies the following conditional expression.

1.0<|f1a/fW|<3.0 (8)

f1a: the focal length of a lens of the most object side of the first lens group

fW: the focal length of the total system in the wide-angle end

Conditional Expression (8) specifies the ratio of the focal length of a lens of the most object side of the first lens group to the focal length of the total system in the wide-angle end. Under the condition of less than the upper limit of Conditional Expression (8), the lens has appropriate negative refractive power and then in the wide-angle end, a wide view angle can be ensured. On the other hand, when the lower limit is exceeded, aberration occurrence due to an increase in the refractive power of the lens can be prevented.

Further, the following conditional expression is more preferably satisfied.

1.5<|f1a/fW|<2.5

7. The zoom lens described in any one of items 1-6, wherein the zoom lens satisfies the following conditional expression.

0.8<|f3/fW|<2.0 (9)

f3: the focal length of the third lens group

fW: the focal length of the total system in the wide-angle end

Conditional Expression (9) specifies the ratio of the focal length of the third lens group to the focal length of the total system in the wide-angle end. Under the condition of less than the upper limit of Conditional Expression (9), the third lens group has appropriate negative refractive power and then a zoom lens can be downsized. On the other hand, when the lower limit is exceeded, aberration occurrence due to an increase in the refractive power of the third lens group can be prevented.

Further, the following conditional expression is more preferably satisfied.

1.0<|f3/fW|<1.5

8. The zoom lens described in any one of items 1-7, wherein the third lens group is formed of a plastic material and at least one surface is aspherically shaped.

Since the second lens group, the third lens group, and the fourth lens group are configured in a “positive-negative-positive” arrangement, the height of a light beam passing through the third lens group is relatively small and thereby the third lens group results in a lens being small in the external shape. Therefore, compared to a glass lens produced via time-consuming polishing processing, a constitution employing a plastic lens produced via injection molding can realize inexpensive mass production. Further, since injection molding can easily produce aspherical lenses, each aberration can be effectively corrected using an aspherical lens. Still further, since in plastic lenses, press temperature can be decreased, a molding die can be prevented from wearing. Thereby, the number of times of exchanging molding dies and the number of times of maintenance can be reduced, resulting in cost reduction.

9. The zoom lens described in any one of items 1-8, wherein the third lens group moves in an optical axis direction to carry out focusing between infinity to finite distance.

Focusing is carried out by the third lens group and thereby a sharp image ranging to a short-distance object can be obtained with no increase in the total optical distance due to extension or no increase in the front lens diameter.

10. The zoom lens described in any one of items 1-9, wherein the fourth lens group does not move during variable magnification or focusing.

The fourth lens group is a lens group closest to the solid-state imaging element, and when the fourth lens group moves during variable magnification or focusing, the distance from the solid-state imaging element decreases and then even the final lens is liable to be affected by dirt or scratches in some cases. In contrast, when the fourth lens group is not allowed to move, the distance between the final lens and the solid-state imaging element is fixed, resulting in prevention of the influence of dirt or scratches.

11. An imaging device provided with a zoom lens described in any one of items 1-10.

An imaging device provided with a zoom lens, while being smaller than the conventional type, having small F-number and well-corrected aberrations can be obtained.

### Effects of the Invention

According to the zoom lens of the present invention and an imaging device provided with the zoom lens, effects, in which while being smaller than the conventional type, F-number is reduced and aberrations are well corrected, are produced.

### BRIEF DESCRIPTION OF THE DRAWINGS

FIG. 1 is an external view of a mobile phone;

FIG. 2 is a cross-sectional view of an imaging device;

FIG. 3 is a cross-sectional view of a zoom lens of Example 1;

FIG. 4 is an aberration figure in the wide-angle end of Example 1;

FIG. 5 is an aberration figure in the intermediate focal length of Example 1;

FIG. 6 is an aberration figure in the telescopic end of Example 1;

FIG. 7 is a cross-sectional view of a zoom lens of Example 2;

FIG. 8 is an aberration figure in the wide-angle end of Example 2;

FIG. 9 is an aberration figure in the intermediate focal length of Example 2;

FIG. 10 is an aberration figure in the telescopic end of Example 2;

FIG. 11 is a cross-sectional view of a zoom lens of Example 3;

FIG. 12 is an aberration figure in the wide-angle end of Example 3;

FIG. 13 is an aberration figure in the intermediate focal length of Example 3;

FIG. 14 is an aberration figure in the telescopic end of Example 3;

FIG. 15 is a cross-sectional view of a zoom lens of Example 4;

FIG. 16 is an aberration figure in the wide-angle end of Example 4;

FIG. 17 is an aberration figure in the intermediate focal length of Example 4;

FIG. 18 is an aberration figure in the telescopic end of Example 4;

FIG. 19 is a cross-sectional view of a zoom lens of Example 5;

FIG. 20 is an aberration figure in the wide-angle end of Example 5;

FIG. 21 is an aberration figure in the intermediate focal length of Example 5; and

FIG. 22 is an aberration figure in the telescopic and of Example 5.

### PREFERRED EMBODIMENT OF THE INVENTION

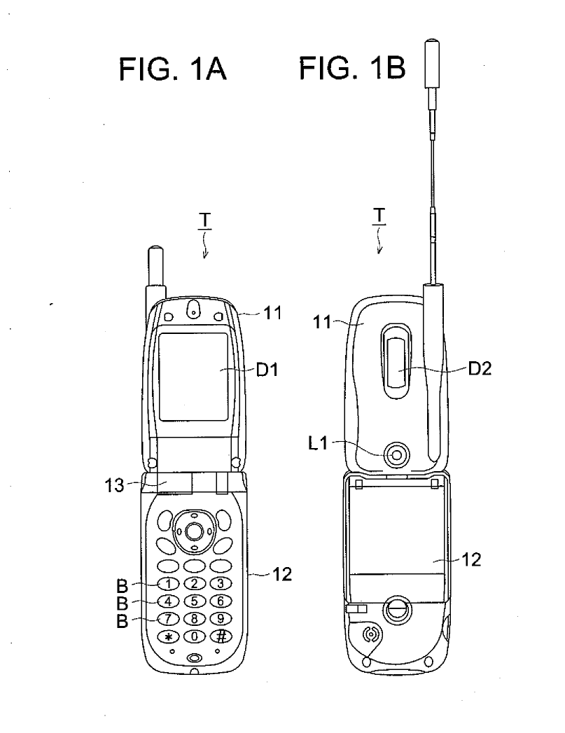

Initially, one example of a mobile phone as a mobile information terminal will now be described based on the external view of FIG. 1. Herein, FIG. 1A is a view in which a folded mobile phone has been opened and then viewed from the inside and FIG. 1B is a view in which the folded mobile phone has been opened and then viewed from the outside.

In FIG. 1, in a mobile phone T, an upper housing 11 serving as a case provided with display screens D1 and D2 and a lower housing 12 provided with operation buttons B are connected to each other via a hinge 13. An imaging device is incorporated below the display screen D2 in the upper housing 11. A first lens L1 of a zoom lens is exposed on the outer surface of the upper housing 11.

Incidentally, this imaging device may be arranged above or on the side of the display screen D2 in the upper housing 11. Further, the mobile phone T is not limited to a foldable one.

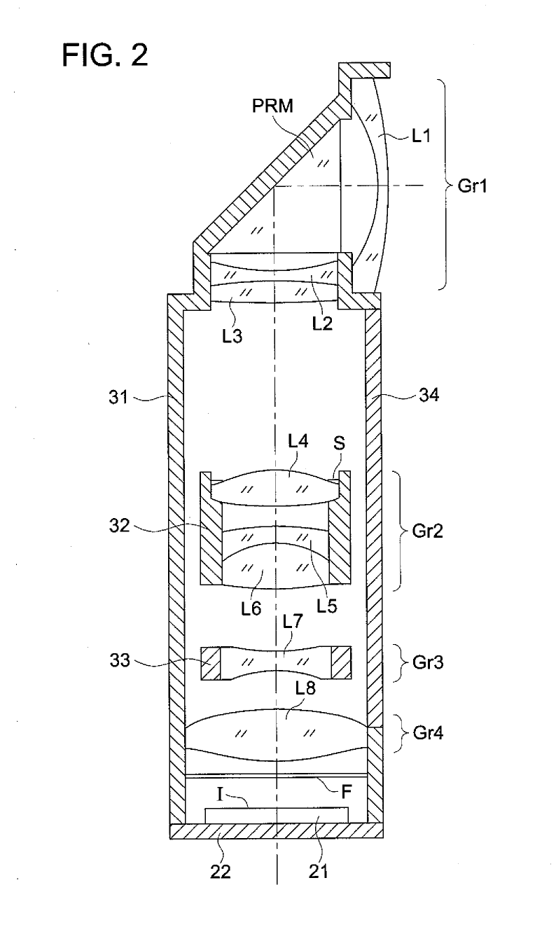

Next, an imaging device, incorporated in the above mobile phone and provided with a zoom lens, will now be described with reference to the cross-sectional view of FIG. 2.

A zoom lens incorporated in the present imaging device contains a first lens group Gr1, a second lens group Gr2, a third lens group Gr3, and a fourth lens group Gr4.

The first lens group Gr1 contains a first lens L1, a reflective optical element PRM, a second lens L2 (a 1n lens), and a third lens L3 (a 1p lens) and has negative refractive power as a whole. Herein, the reflective optical element PRM is, for example, a right angle prism.

A light beam from an object is passed through the first lens L1 and then reflected at the reflective optical element PRM, followed by being bent at right angles to pass through the second lens L2 and the third lens L3 as a cemented lens. Therefore, the optical axis OA of the first lens L1 and the optical axis OB of the second lens L2 and the third lens L3 intersect at nearly right angles. Herein, the first lens group Gr1 is fixed to the housing 31 and will not be moved.

The second lens group Gr2 contains a fourth lens L4 (a 2 μl lens) and a cemented lens of a fifth lens L5 (a 2n lens) and a sixth lens L6 (a 2p2 lens) and has positive refractive power as a whole. The second lens group Gr2 is held by a minor cell 32, and the mirror cell 32 is driven by an unshown drive member during variable magnification and then the second lens group Gr2 is moved back and forth along the optical axis OB. Herein, an optical stop S is arranged in front of the fourth lens L4.

The third lens group Gr3 contains a single seventh lens L7 and has negative refractive power. The third lens group Gr3 is held by a minor cell 33, and the minor cell 23 is driven by an unshown drive member during variable magnification and then the third lens group Gr3 is moved back and forth along the optical axis OB. Further, the third lens Gr3 moves along the optical axis OB for focusing between infinity and finite distance after termination of variable magnification.

The fourth lens group Gr4 contains a single eighth lens L8 and has positive refractive power. The fourth lens group Gr4 is fixed to the housing 31 and will not be moved.

A parallel flat plate F is an optical low-pass filter or an IR cut filter or may be a seal glass of the solid-state imaging element.

As described above, using a zoom lens containing a first lens group Gr1, a second lens group Gr2, a third lens group Gr3, a the fourth lens group Gr4, an optical image of an object is focused on the imaging plane I of an imaging element 21 located at the back of the fourth lens group Gr4. Incidentally, the imaging element 21 is mounted in a printed circuit board 22, which is fixed to the housing 31.

Each of the members including a zoom lens is mounted in the housing 31 and thereafter covered by a lid member 34.

### EXAMPLES

Examples of the zoom lens of the present invention will now be described. Symbols used in each example are listed below.

f the focal length of the total imaging lens system

fB: back-focus (a value obtained by air conversion of a parallel flat plate located at the final portion)

F: F-number

2Y: the imaging plane diagonal length of a solid-state imaging element

R: curvature radius

D: axial surface distance

Nd: the refractive index with respect to d-line of a lens material

νd: the Abbe number of a lens material

2ω: view angle

L: total lens length

Further, in each example, a surface in which “*” is attached after each surface number is one having an aspherical shape. The shape of an aspherical surface is represented by Mathematical Expression 1 described below in which the top of the surface is allowed to be the origin; then X axis is assigned in the optical axis direction; and the height in the vertical direction with impact to the optical axis is designated as h.

$$X = \frac{{h}^{2} / R}{1 + \sqrt{1 - ( 1 + K ) {h}^{2} / {R}^{2}}} + \sum {A}_{i} {h}^{i}$$

Ai: i-th aspherical coefficient

R: curvature radius

K: conic constant

Further, in an aspherical coefficient, a power of 10 (e.g., 2.5×10⁻⁰²) is represented using E (e.g., 2.5E-02).

### Example 1

All specifications are shown below.

| | |
|---|---|
| f | 4.57-7.46-12.56 |
| F | 3.09-4.21-5.60 |
| Zoom ratio | 2.75 |
| 2Y | 5.712 |

Surface data is shown below.

| | | | | | Effective |
|---|---|---|---|---|---|
| Surface | | | | | Radius |
| Number | R (mm) | D (mm) | Nd | νd | (mm) |
| 1 | 16.036 | 0.400 | 1.90370 | 31.3 | 3.56 |
| 2 | 5.414 | 1.469 | | | 3.13 |
| 3 | ∞ | 5.263 | 1.84670 | 23.8 | 3.02 |
| 4 | ∞ | 0.692 | | | 2.42 |
| 5 | −8.292 | 0.400 | 1.60310 | 60.7 | 2.34 |
| 6 | 16.844 | 0.863 | 1.92290 | 20.9 | 2.32 |
| 7 | −47.226 | d1(variable) | | | 2.30 |
| 8(optical stop) | ∞ | −0.400 | | | 2.07 |
| 9(*) | 4.529 | 1.427 | 1.59200 | 67.0 | 2.08 |
| 10(*) | −14.904 | 0.784 | | | 2.08 |
| 11 | 10.687 | 0.658 | 1.90370 | 31.3 | 1.93 |
| 12 | 3.452 | 1.809 | 1.49700 | 81.6 | 1.77 |
| 13(*) | −9.968 | d2(variable) | | | 1.72 |
| 14(*) | −7.875 | 0.764 | 1.54470 | 56.2 | 1.67 |
| 15(*) | 4.842 | d3(variable) | | | 1.77 |
| 16(*) | 10.887 | 2.055 | 1.54470 | 56.2 | 3.03 |
| 17(*) | −8.551 | 0.500 | | | 3.05 |
| 18 | ∞ | 0.145 | 1.51680 | 64.2 | 2.97 |
| 19 | ∞ | | | | 2.96 |

Aspherical coefficients are shown below.

Ninth Surface
K = 0.00000E+00, A4 = −0.12865E−02, A6 = −0.25566E−03,
A8 = 0.59066E−05, A10 = −0.35576E−06, A12 = −0.11679E−05
Tenth Surface
K = 0.00000E+00, A4 = 0.90262E−03, A6 = −0.59106E−03,
A8 = 0.12607E−03, A10 = −0.26978E−04, A12 =0.11799E−05
Thirteenth Surface
K = 0.00000E+00, A4 = 0.68016E−03, A6 = 0.85807E−03,
A8 = −0.34213E−03, A10 = 0.10128E−03, A12 = 0.11056E−04
Fourteenth Surface
K = 0.00000E+00, A4 = −0.10089E−01, A6 = 0.13666E−01,
A8 = −0.88298E−02, A10 = 0.34045E−02, A12 = −0.71040E−03,
A14 = 0.59563E−04
Fifteenth Surface
K = 0.00000E+00, A4 = −0.12342E−01, A6 = 0.15561E−01,
A8 = −0.92910E−02, A10 = 0.32767E−02, A12 = −0.61889E−03,
A14 = 0.47102F−04
Sixteenth Surface
K = 0.00000E+00, A4 = −0.18300E−02, A6 = 0.20409E−03,
A8 = 0.16125E−04, A10 = −0.24733E−05, A12 = 0.95434E−07
Seventeenth Surface
K = 0.00000E+00, A4 = 0.22282E−02, A6 = −0.75710E−03,
A8 = 0.14572E−03, A10 = −0.11224E−04, A12 = 0.32698E−06

Data during variable magnification is shown below.

| | Wide-Angle | Intermediate | Telescopic |
|---|---|---|---|
| f | 4.57 | 7.46 | 12.57 |
| F | 3.09 | 4.21 | 5.60 |
| fB | 1.77 | 1.76 | 1.77 |
| 2ω | 66.6 | 41.4 | 24.9 |
| L | 28.98 | 28.96 | 28.98 |
| d1 | 7.000 | 4.031 | 0.900 |
| d2 | 2.455 | 2.841 | 4.490 |
| d3 | 1.518 | 4.100 | 5.582 |

Lens group data is shown below.

| Group | Initial Surface | Focal Length (mm) |
|---|---|---|
| 1 | 1 | −6.36 |
| 2 | 8 | 5.73 |
| 3 | 14 | −5.39 |
| 4 | 16 | 9.13 |

Values corresponding to each conditional expression described above are shown below.

n2n − n2p2 = 0.407
v2p2 − v2n = 50.3
|f1b/fT| = 2.408
v1n − v1p = 39.8
(r12n + r22n)/(r12n − r22n) = 1.954
(r12p2 + r22p2)/(r12p2 − r22p2) = −0.486
f2n2p2/f2p1 = 8.131
|f1a/fW| = 2.016
|f3/fW| = 1.180

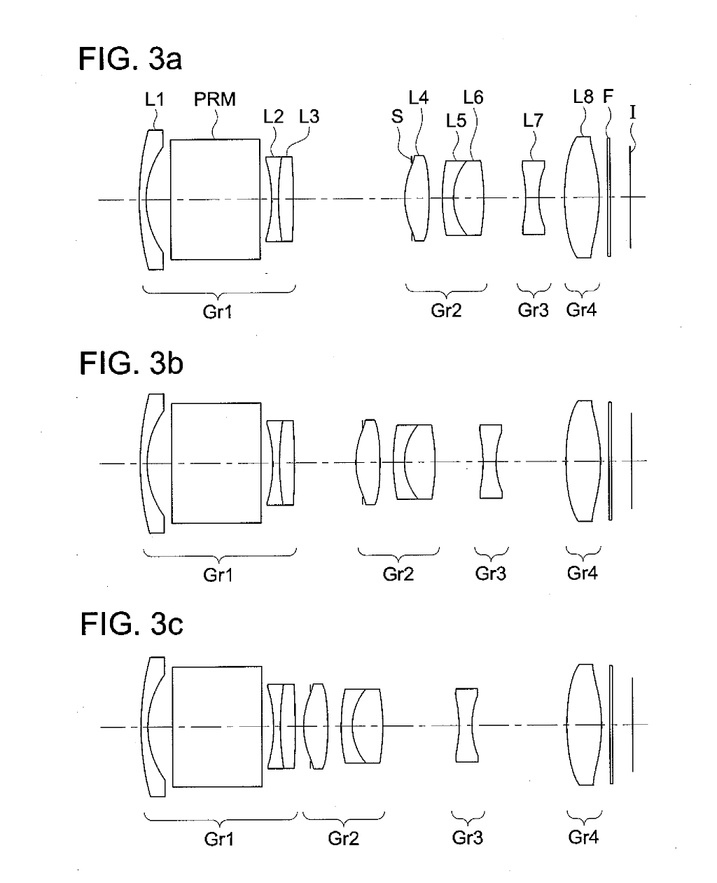

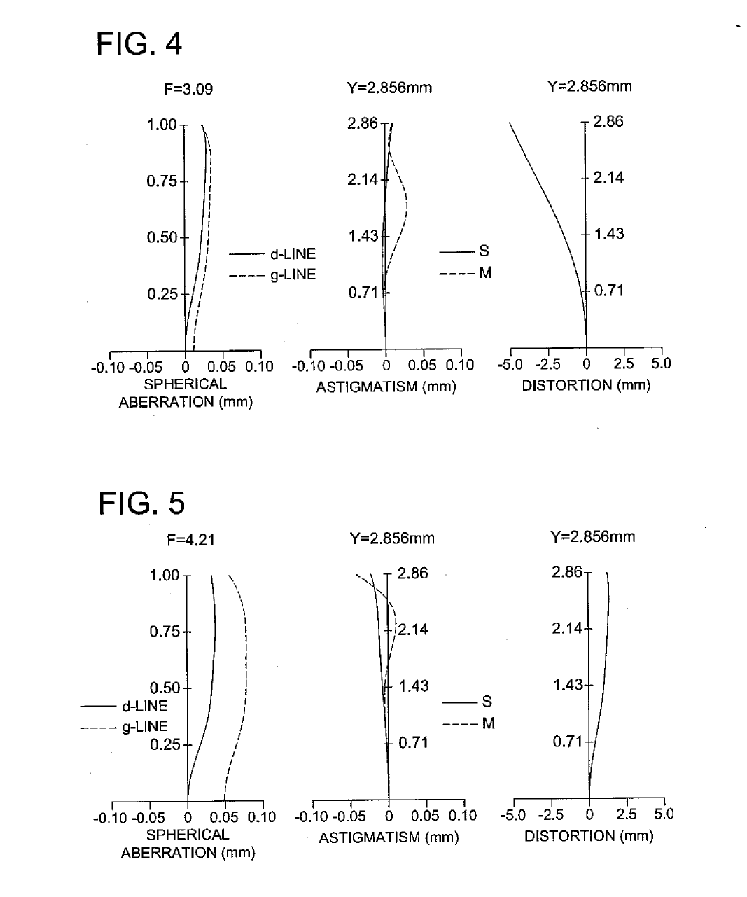

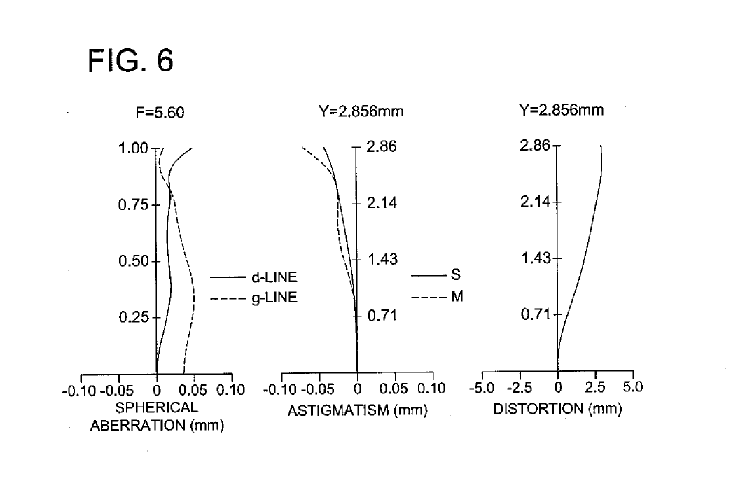

FIG. 3 is a cross-sectional view of a zoom lens. FIG. 3A is a cross-sectional view in the wide-angle end; FIG. 3B is a cross-sectional view in the middle; and FIG. 3C is a cross-sectional view in the telescopic end. Incidentally, a reflective optical element PRM is represented as a parallel flat plate equivalent to its optical path length, which is the same as in cross-sectional views of zoom lenses in other examples. FIG. 4 is an aberration figure in the wide-angle end; FIG. 5 is an aberration figure in the intermediate focal length; and FIG. 6 is an aberration figure in the telescopic end.

In the present zoom lens, the second lens group Gr2 moves to the object side in the optical axis direction during variable magnification from the wide-angle end to the telescopic end and the third lens group Gr3 moves to the object side in the optical axis direction to change the distances between the lens groups for variable magnification. The remaining lens groups are fixed during variable magnification. Further, when the third lens group Gr3 is allowed to move, focusing between infinity to finite distance can be carried out. Incidentally, the fourth lens IA and the sixth lens L6 are glass mold lenses and the seventh lens L7 and the eighth lens L8 are formed of a plastic material. The lenses other than these are assumed to be polished lenses employing a glass material.

Further, with reduction of the total zoom lens length, since it is necessary to converge, at short distance, incident light having been diffused by the negative power of the first lens group Gr1, the refractive power of the fourth lens Gr4 tends to increase. Therefore, the eccentric error sensitivity of the fourth lens L4 increases. Therefor, when the fourth lens L4 is aligned, asymmetrical blur in the image plane referred to as one-sided blur generated in the total system can be reduced. In the present example, since F-number is smaller in the wide-angle end than in the telescopic and, focal depth is small and then the influence of one-side blur is liable to be produced. Then, it is assumed that this alignment is made in the wide-angle end.

Herein, alignment is to allow a lens to be eccentric with respect to the optical axis to cancel and reduce one-sided blur resulting from lenses other than the fourth lens L4. Herein, in the case of eccentricity with respect to the optical axis, not only parallel eccentricity but also inclined eccentricity may be carried out. Further, eccentricity may be performed not to reduce one-sided blur, but to reduce axial come aberration.

### Example 2

All specifications are shown below.

| | |
|---|---|
| f | 4.50-7.37-12.36 |
| F | 3.09-4.23-5.60 |
| Zoom ratio | 2.75 |
| 2Y | 5.712 |

Surface data is shown below.

| | | | | | Effective |
|---|---|---|---|---|---|
| Surface | | | | | Radius |
| Number | R (mm) | D (mm) | Nd | νd | (mm) |
| 1 | 16.186 | 0.400 | 1.90370 | 31.3 | 3.59 |
| 2 | 5.389 | 1.478 | | | 3.14 |
| 3 | ∞ | 5.244 | 1.84670 | 23.8 | 3.04 |
| 4 | ∞ | 0.712 | | | 2.44 |
| 5 | −8.038 | 0.400 | 1.62040 | 60.3 | 2.36 |
| 6 | 16.165 | 0.893 | 1.92290 | 20.9 | 2.35 |
| 7 | −41.475 | d1(variable) | | | 2.33 |
| 8(optical stop) | ∞ | −0.400 | | | 2.06 |
| 9(*) | 4.450 | 1.522 | 1.59200 | 67.0 | 2.07 |
| 10(*) | −24.000 | 0.784 | | | 2.03 |
| 11 | 13.207 | 0.400 | 1.90370 | 31.3 | 1.89 |
| 12 | 3.679 | 1.725 | 1.55330 | 71.7 | 1.79 |
| 13(*) | −9.238 | d2(variable) | | | 1.74 |
| 14(*) | −7.882 | 0.500 | 1.53050 | 55.7 | 1.67 |
| 15(*) | 4.350 | d3∞(variable) | | | 1.75 |
| 16(*) | 7.918 | 2.360 | 1.53050 | 55.7 | 3.10 |
| 17(*) | −9.232 | 0.638 | | | 3.05 |
| 18 | ∞ | 0.145 | 1.51680 | 64.2 | 2.94 |
| 19 | ∞ | | | | 2.93 |

Aspherical coefficients are shown below.

Ninth Surface
K = 0.00000E+00, A4 = −0.80508E−03, A6 = −0.28702E−03,
A8 = 0.59039E−04, A10 = −0.13413E−04, A12 = 0.30875E−06
Tenth Surface
K = 0.00000E+00, A4 = 0.11991E−02, A6 = −0.49333E−03,
A8 = 0.11716E−03, A10 = −0.29390E−04, A12 = 0.18122E−05
Thirteenth Surface
K = 0.00000E+00, A4 = 0.95975E−03, A6 = 0.43519E−03,
A8 = −0.11841E−03, A10 = 0.38922E−04, A12 = 0.38874E−05
Fourteenth Surface
K = 0.00000E+00, A4 = −0.15458E−01, A6 = 0.19098E−01,
A8 = −0.11687E−01, A10 = 0.46483E−02, A12 = −0.11413E−02,
A14 = 0.14953E−03, A16 = −0.74854E−05
Fifteenth Surface
K = 0.00000E+00, A4 = −0.19003E−01, A6 = 0.22170E−01,
A8 = −0.13667E−01, A10 = 0.55552E−02, A12 = −0.14041E−02,
A14 = 0.19428E−03, A16 = −0.10994E−04
Sixteenth Surface
K = 0.00000E+00, A4 = −0.22839E−02, A6 = 0.37247E−03,
A8 = −0.19323E−04, A10 = 0.12432E−05, A12 = −0.37042E−07
Seventeenth Surface
K = 0.00000E+00, A4 = 0.25911E−02, A6 = −0.55882E−03,
A8 = 0.72992E−04, A10 = −0.24699E−05, A12 = 0.72330E−08

Data during variable magnification is shown below.

| | Wide-Angle | Intermediate | Telescopic |
|---|---|---|---|
| f | 4.50 | 7.37 | 12.36 |
| F | 3.09 | 4.23 | 5.60 |
| fB | 1.27 | 1.27 | 1.30 |
| 2ω | 67.5 | 41.9 | 25.3 |
| L | 28.99 | 28.99 | 29.01 |
| d1 | 6.919 | 3.999 | 0.900 |
| d2 | 3.233 | 3.637 | 5.361 |
| d3 | 1.497 | 4.013 | 5.388 |

Lens group data is shown below.

| Group | Initial Surface | Focal Length (mm) |
|---|---|---|
| 1 | 1 | −6.20 |
| 2 | 8 | 5.82 |
| 3 | 14 | −5.21 |
| 4 | 16 | 8.44 |

Values corresponding to each conditional expression described above are shown below.

n2n − n2p2 = 0.350
v2p2 − v2n = 40.4
|f1b/fT| = 2.322
v1n − v1p = 39.5
(r12n + r22n)/(r12n − r22n) = 1.772
(r12p2 + r22p2)/(r12p2 − r22p2) = −0.430
f2n2p2/f2p1 = 4.379
|f1a/fW| = 2.024
|f3/fW| = 1.159

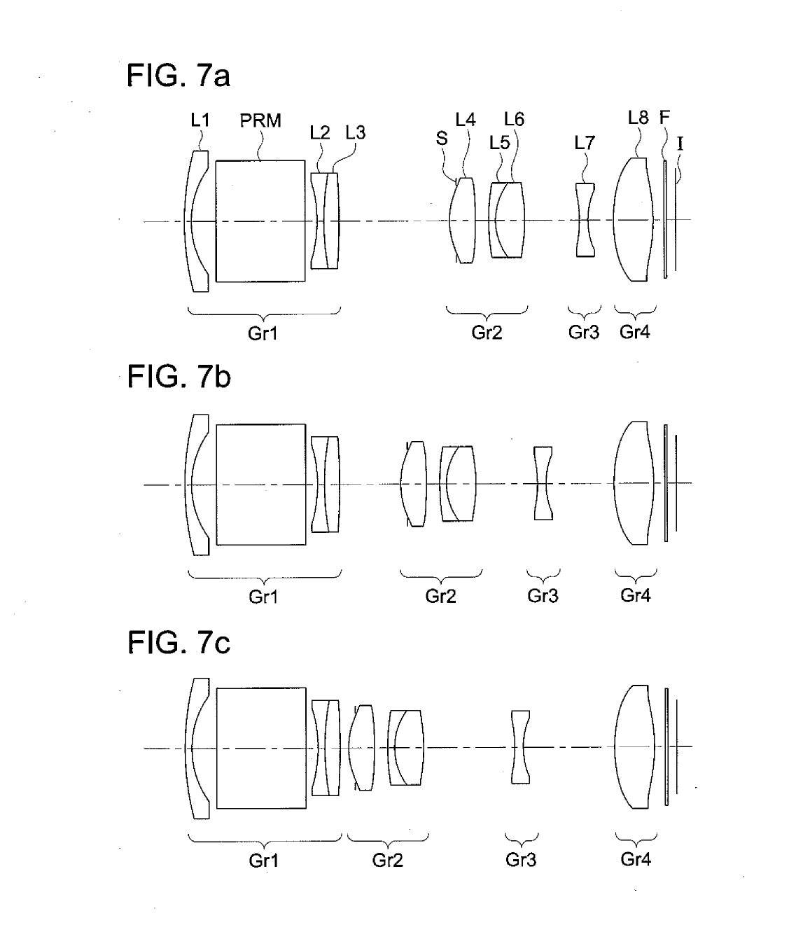

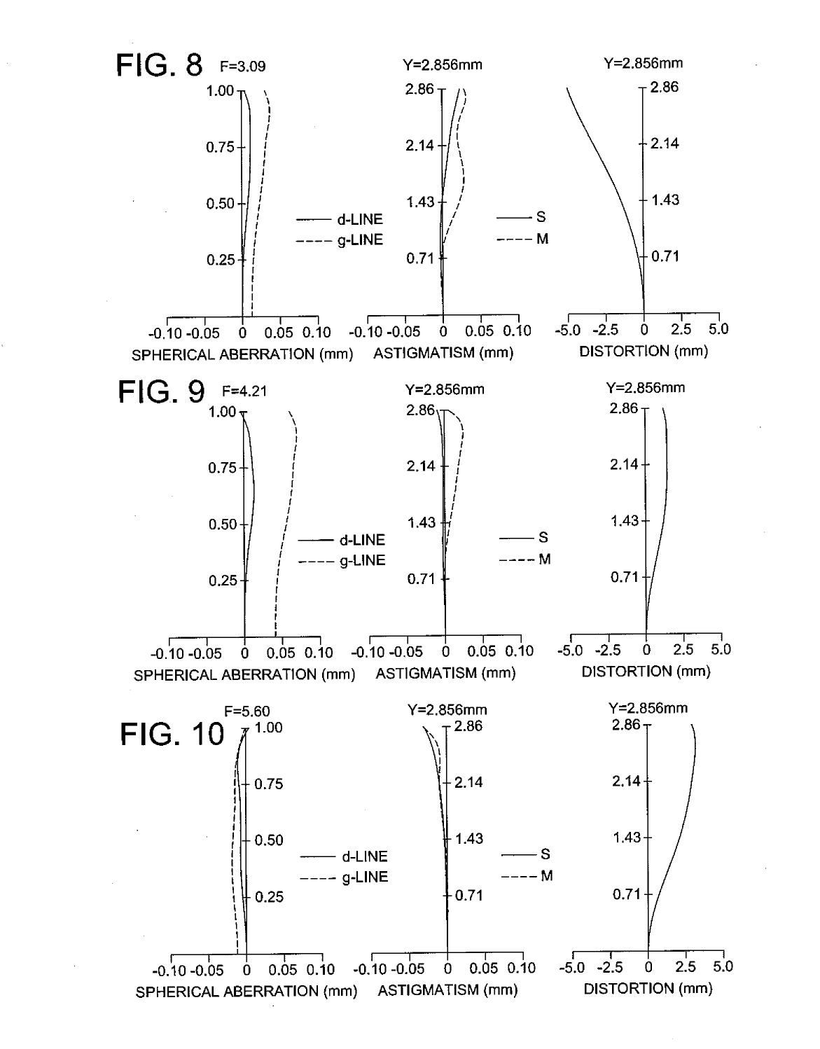

FIG. 7 is a cross-sectional view of a zoom lens. FIG. 7A is a cross-sectional view in the wide-angle end; FIG. 7B is a cross-sectional view in the middle; and FIG. 7C is a cross-sectional view in the telescopic end. FIG. 8 is an aberration figure in the wide-angle end; FIG. 9 is an aberration figure in the intermediate focal length; and FIG. 10 is an aberration figure in the telescopic end.

In the present zoom lens, the second lens group Gr2 moves to the object side in the optical axis direction during variable magnification from the wide-angle end to the telescopic end and the third lens group Gr3 moves to the object side in the optical axis direction to change the distances between the lens groups for variable magnification. The remaining lens groups are fixed during variable magnification. Further, when the third lens group Gr3 is allowed to move, focusing between infinity to finite distance can be carried out. Incidentally, the fourth lens L4 and the sixth lens L6 are glass mold lenses, and the seventh lens L7 and the eighth lens L8 are formed of a plastic material. The lenses other than these are assumed to be polished lenses employing a glass material.

Further, in the present example, it is assumed that alignment using the fourth lens is made in the wide-angle end.

### Example 3

All specifications are shown below.

| | |
|---|---|
| f | 4.18-6.66-11.50 |
| F | 3.17-4.20-5.60 |
| Zoom ratio | 2.75 |
| 2Y | 5.712 |

Surface data is shown below.

| | | | | | Effective |
|---|---|---|---|---|---|
| Surface | | | | | Radius |
| Number | R (mm) | D (mm) | Nd | νd | (mm) |
| 1 | 20.330 | 0.400 | 1.88300 | 40.8 | 3.70 |
| 2 | 5.731 | 1.446 | | | 3.23 |
| 3 | ∞ | 5.309 | 1.84670 | 23.8 | 3.13 |
| 4 | ∞ | 0.755 | | | 2.44 |
| 5 | −7.414 | 0.400 | 1.56880 | 56.0 | 2.35 |
| 6 | 15.979 | 0.839 | 1.92290 | 20.9 | 2.33 |
| 7 | −83.206 | d1(variable) | | | 2.30 |
| 8(optical stop) | ∞ | 0.000 | | | 1.85 |
| 9(*) | 4.100 | 1.460 | 1.59200 | 67.0 | 1.96 |
| 10(*) | −110.519 | 0.400 | | | 1.92 |
| 11 | 5.777 | 0.400 | 1.90370 | 31.3 | 1.84 |
| 12 | 2.883 | 1.762 | 1.49700 | 81.6 | 1.71 |
| 13(*) | −17.287 | d2(variable) | | | 1.62 |
| 14(*) | −44.959 | 0.500 | 1.53050 | 55.7 | 1.60 |
| 15(*) | 3.040 | d3(variable) | | | 1.66 |
| 16(*) | 15.051 | 2.421 | 1.53050 | 55.7 | 3.15 |
| 17(*) | −4.696 | 0.900 | | | 3.21 |
| 18 | ∞ | 0.500 | 1.51680 | 64.2 | 2.98 |
| 19 | ∞ | | | | 2.93 |

Aspherical coefficients are shown below.

Ninth Surface
K = 0.00000E+00, A4 = −0.12187E−02, A6 = −0.44343E−04,
A8 = −0.26551E−04, A10 = 0.10028E−05, A12 = −0.44275E−06
Tenth Surface
K = 0.00000E+00, A4 = 0.31600E−03, A6 = −0.42536E−03,
A8 = 0.14596E−03, A10 = −0.42847E−04, A12 = 0.36834E−05
Thirteenth Surface
K = 0.00000E+00, A4 = 0.32486E−02, A6 = 0.45824−04,
A8 = 0.10909E−03, A10 = 0.55701E−05, A12 = −0.32582E−05
Fourteenth Surface
K = 0.00000E+00, A4 = −0.16478E−01, A6 = 0.14232E−01,
A8 = −0.92199E−02, A10 = 0.34961E−02, A12 = −0.71040E−03,
A14 = 0.59563E−04
Fifteenth Surface
K = 0.00000E+00, A4 = −0.19271E−01, A6 = 0.16248E−01,
A8 = −0.10542E−01, A10 = 0.39007E−02, A12 = −0.77105E−03,
A14 = 0.62141E−04
Sixteenth Surface
K = 0.00000E+00, A4 = −0.12439E−02, A6 = 0.24814E−03,
A8 = −0.55012E−05, A10 = −0.88920E−08
Seventeenth Surface
K = 0.00000E+00, A4 = 0.28368E−02, A6 = −0.12210E−03,
A8 = 0.24703E−04, A10 = −0.76532E−06

Data during variable magnification is shown below.

| | Wide-Angle | Intermediate | Telescopic |
|---|---|---|---|
| f | 4.18 | 6.67 | 11.50 |
| F | 3.17 | 4.20 | 5.60 |
| fB | 1.74 | 1.71 | 1.69 |
| 2ω | 71.3 | 46.0 | 27.2 |
| L | 28.46 | 28.43 | 28.41 |
| d1 | 6.290 | 3.569 | 0.500 |
| d2 | 2.456 | 2.913 | 4.791 |
| d3 | 1.713 | 3.978 | 5.169 |

Lens group data is shown below.

| Group | Initial Surface | Focal Length (mm) |
|---|---|---|
| 1 | 1 | −5.76 |
| 2 | 8 | 5.39 |
| 3 | 14 | −5.35 |
| 4 | 16 | 7.05 |

Values corresponding to each conditional expression described above are shown below.

n2n − n2p2 = 0.407
v2p2 − v2n = 50.3
|f1b/fT| = 2.043
v1n − v1p = 35.2
(r12n + r22n)/(r12n − r22n) = 2.992
(r12p2 + r22p2)/(r12p2 − r22p2) = −0.714
f2n2p2/f2p1 = 3.162
|f1a/fW| = 2.189
|f3/fW| = 1.279

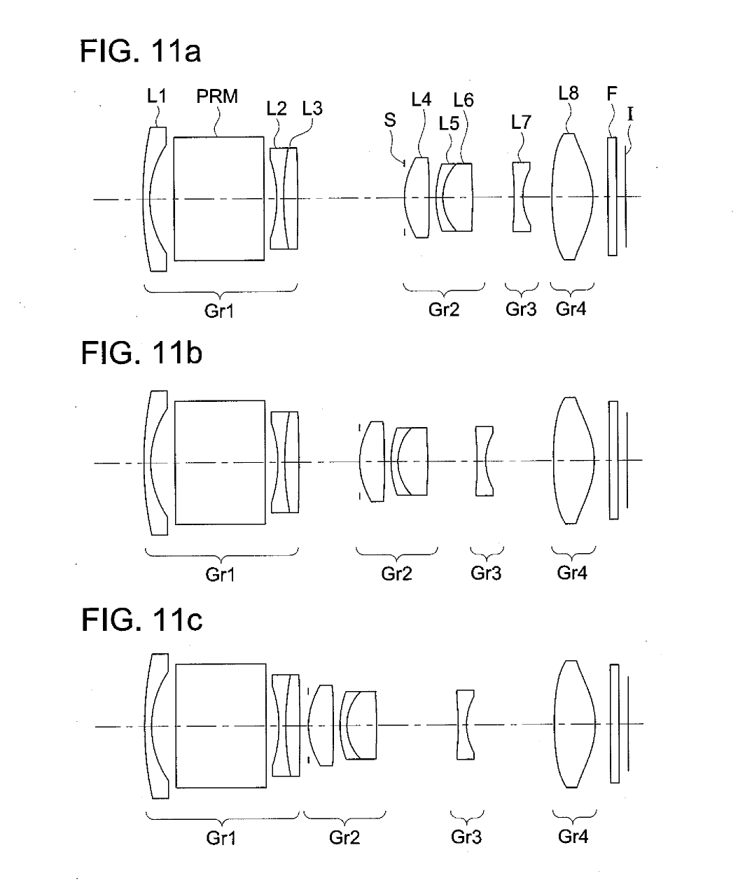

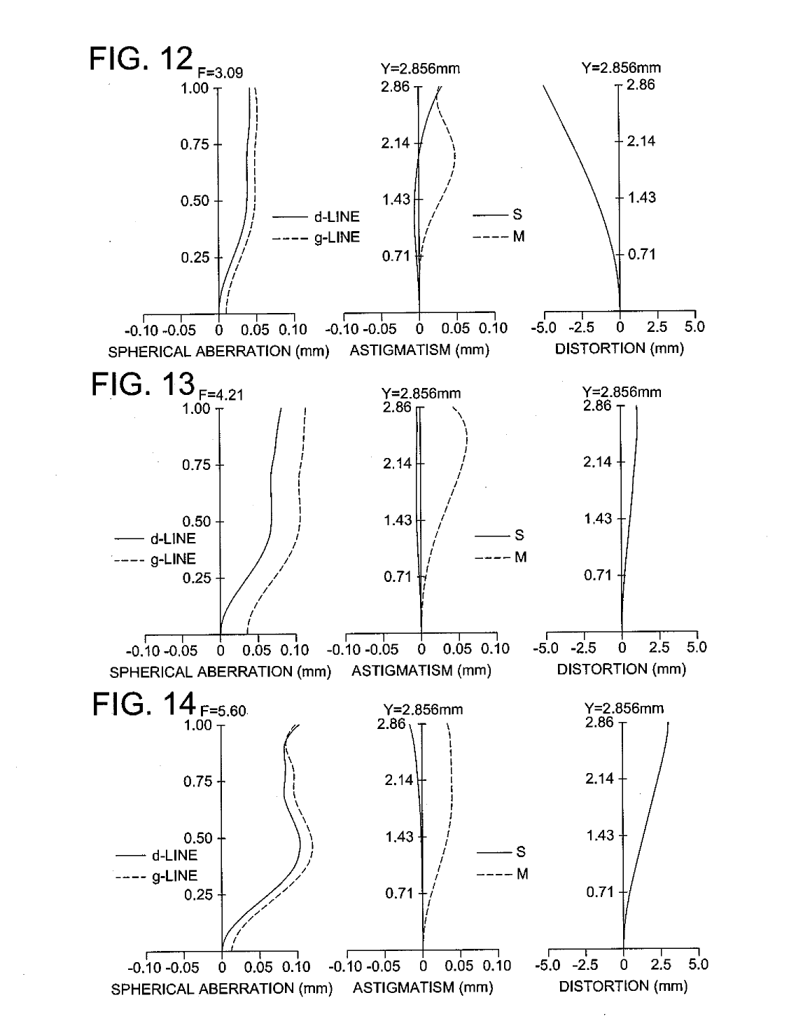

FIG. 11 is a cross-sectional view of a zoom lens. FIG. 11A is a cross-sectional view in the wide-angle end; FIG. 11B is a cross-sectional view in the middle; and FIG. 11C is a cross-sectional view in the telescopic end. FIG. 12 is an aberration figure in the wide-angle end; FIG. 13 is an aberration figure in the intermediate focal length; and FIG. 14 is an aberration figure in the telescopic end.

In the present zoom lens, the second lens group Gr2 moves to the object side in the optical axis direction during variable magnification from the wide-angle end to the telescopic end and the third lens group Gr3 moves to the object side in the optical axis direction to change the distances between the lens groups for variable magnification. The remaining lens groups are fixed during variable magnification. Further, when the third lens group Gr3 is allowed to move, focusing between infinity to finite distance can be carried out. Incidentally, the fourth lens L4 and the sixth lens L6 are glass mold lenses, and the seventh lens L7 and the eighth lens L8 are formed of a plastic material. The lenses other than these are assumed to be polished lenses employing a glass material.

Further, in the present example, it is assumed that alignment using the fourth lens is made in the wide-angle end.

### Example 4

All specifications are shown below.

| | |
|---|---|
| f | 4.17-6.96-11.46 |
| F | 3.13-4.28-5.60 |
| Zoom ratio | 2.75 |
| 2Y | 5.712 |

Surface data is shown below.

| | | | | | Effective |
|---|---|---|---|---|---|
| Surface | | | | | Radius |
| Number | R (mm) | D (mm) | Nd | νd | (mm) |
| 1 | 13.465 | 0.400 | 1.90370 | 31.3 | 3.70 |
| 2 | 4.547 | 1.550 | | | 3.13 |
| 3 | ∞ | 5.100 | 1.90370 | 31.3 | 3.07 |
| 4 | ∞ | 0.609 | | | 2.57 |
| 5 | −11.214 | 0.400 | 1.63850 | 55.5 | 2.51 |
| 6 | 10.132 | 0.993 | 1.92290 | 20.9 | 2.49 |
| 7 | 967.514 | d1(variable) | | | 2.44 |
| 8(optical stop) | ∞ | 0.000 | | | 1.95 |
| 9(*) | 4.486 | 1.534 | 1.58910 | 61.4 | 2.01 |
| 10(*) | −13.829 | 0.816 | | | 1.99 |
| 11 | 11.698 | 0.400 | 1.90370 | 31.3 | 1.81 |
| 12 | 2.846 | 2.070 | 1.58910 | 61.4 | 1.68 |
| 13(*) | −9.542 | d2(variable) | | | 1.65 |
| 14(*) | −13.600 | 0.700 | 1.53050 | 55.7 | 1.62 |
| 15(*) | 3.499 | d3(variable) | | | 1.74 |
| 16(*) | 14.798 | 2.032 | 1.53050 | 55.7 | 3.04 |
| 17(*) | −5.551 | 0.420 | | | 3.18 |
| 18 | ∞ | 0.500 | 1.51680 | 64.2 | 3.09 |
| 19 | ∞ | | | | 3.06 |

Aspherical coefficients are shown below.

Ninth Surface
K = 0.00000E+00, A4 = −0.13836E−02, A6 = −0.35486E−03,
A8 = 0.72102E−04, A10 = −0.17349E−04, A12 = 0.68091E−06
Tenth Surface
K = 0.00000E+00, A4 = 0.80129E−03, A6 = −0.48983E−03,
A8 = 0.11920E−03, A10 = −0.29969E−04, A12 = 0.20069E−05
Thirteenth Surface
K = 0.00000E+00, A4 = 0.29050E−04, A6 = 0.24238E−04,
A8 = 0.56053E−05, A10 = 0.85510E−05, A12 = −0.23055E−05
Fourteenth Surface
K = 0.00000E+00, A4 = −0.19149E−01, A6 = 0.14382E−01,
A8 = −0.96269E−02, A10 = 0.43559E−02, A12 = −0.11413E−02,
A14 = 0.14953E−03, A16 = −0.74854E−05
Fifteenth Surface
K = 0.00000E+00, A4 = −0.22422E−01, A6 = 0.18170E−01,
A8 = −0.12188E−01, A10 = 0.53726E−02, A12 = −0.14040E−02,
A14 = 0.19428E−03, A16 = −0.10994E−04
Sixteenth Surface
K = 0.00000E+00, A4 = −0.27150E−02, A6 = 0.45941E−03,
A8 = −0.16538E−04, A10 = 0.49293E−06
Seventeenth Surface
K = 0.00000E+00, A4 = −0.25226E−04, A6 = 0.27389E−03

Data during variable magnification is shown below.

| | Wide-Angle | Intermediate | Telescopic |
|---|---|---|---|
| f | 4.17 | 6.96 | 11.46 |
| F | 3.13 | 4.28 | 5.60 |
| fB | 1.29 | 1.28 | 1.29 |
| 2ω | 71.6 | 44.1 | 27.2 |
| L | 28.49 | 28.48 | 28.49 |
| d1 | 6.248 | 3.363 | 0.500 |
| d2 | 2.560 | 2.908 | 4.437 |
| d3 | 1.619 | 4.156 | 5.490 |

Lens group data is shown below.

| Group | Initial Surface | Focal Length (mm) |
|---|---|---|
| 1 | 1 | −5.70 |
| 2 | 8 | 5.56 |
| 3 | 14 | −5.17 |
| 4 | 16 | 7.88 |

Values corresponding to each conditional expression described above are shown below.

n2n − n2p2 = 0.315
v2p2 − v2n = 30.1
|f1b/fT| = 2.961
v1n − v1p = 34.6
(r12n + r22n)/(r12n − r22n) = 1.643
(r12p2 + r22p2)/(r12p2 − r22p2) = −0.541
f2n2p2/f2p1 = 5.302
|f1a/fW| = 1.863
|f3/fW| = 1.241

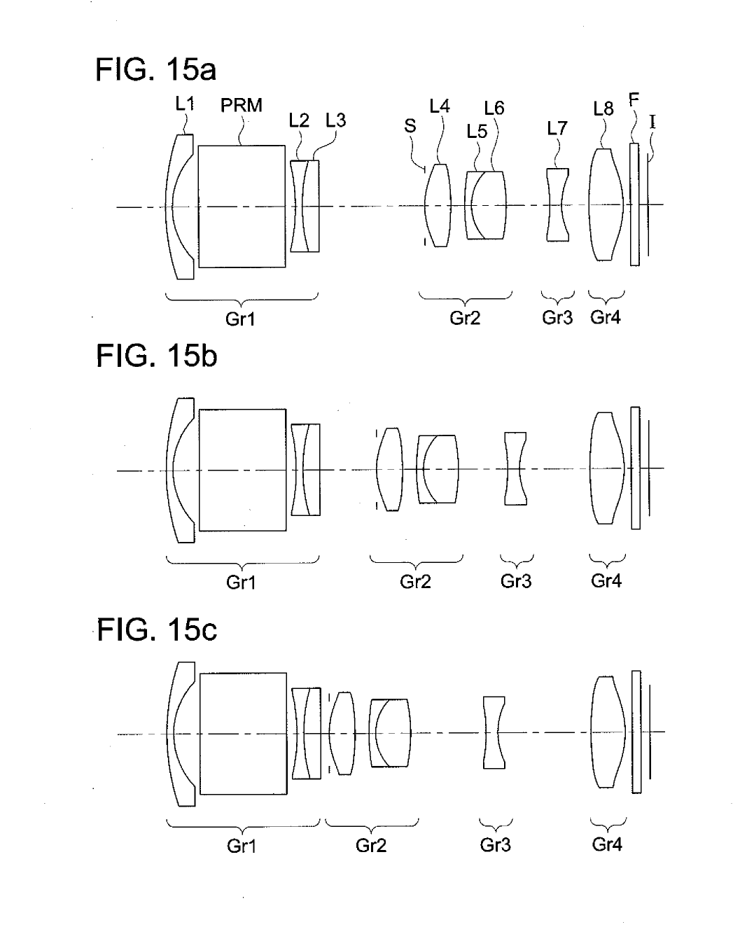

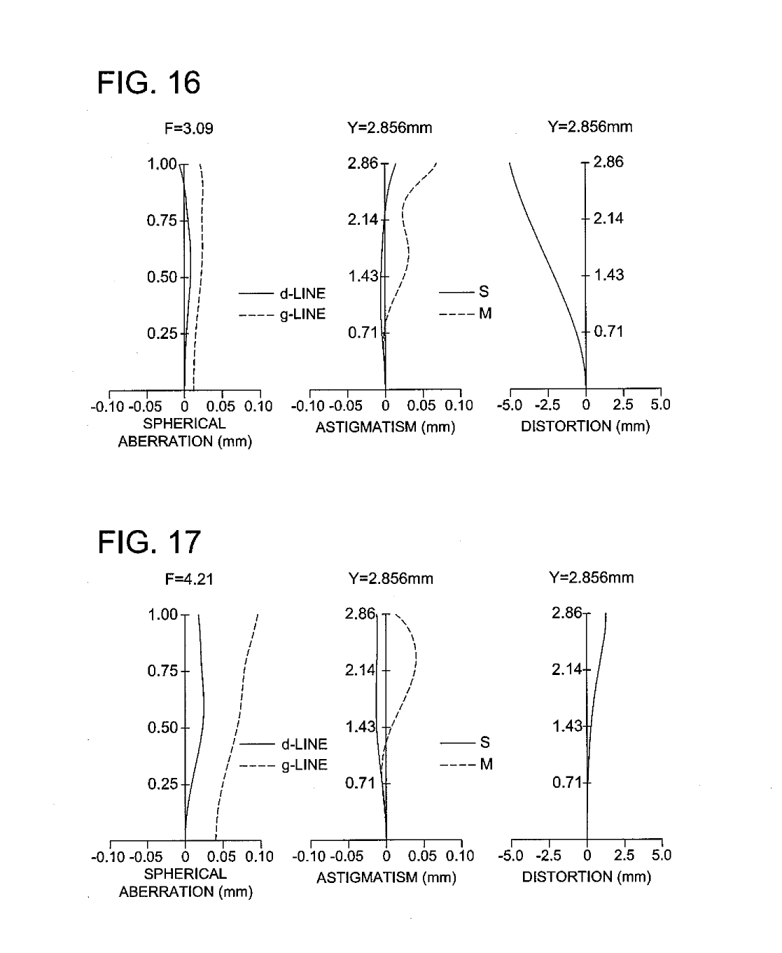

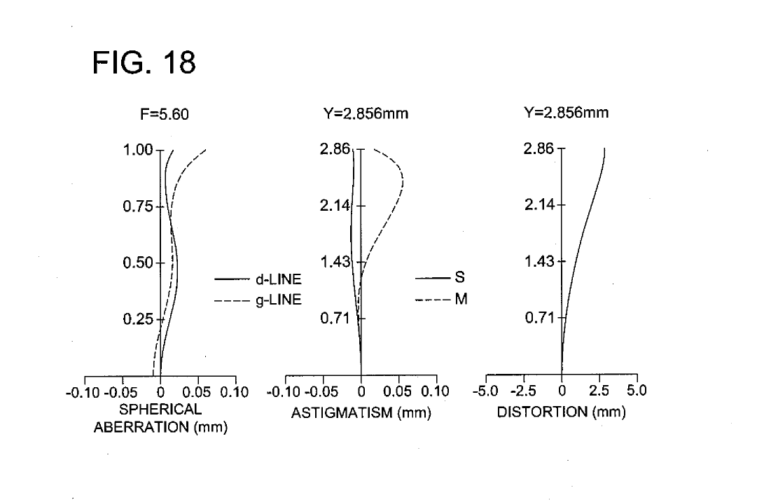

FIG. 15 is a cross-sectional view of a zoom lens. FIG. 15A is a cross-sectional view in the wide-angle end; FIG. 15B is a cross-sectional view in the middle; and FIG. 15C is a cross-sectional view in the telescopic end FIG. 16 is an aberration figure in the wide-angle end; FIG. 17 is an aberration figure in the intermediate focal length; and FIG. 18 is an aberration figure in the telescopic end.

In the present zoom lens, the second lens group Gr2 moves to the object side in the optical axis direction during variable magnification from the wide-angle end to the telescopic end and the third lens group Gr3 moves to the object side in the optical axis direction to change the distances between the lens groups for variable magnification. The remaining lens groups are fixed during variable magnification. Further, when the third lens group Gr3 is allowed to move, focusing between infinity to finite distance can be carried out. Incidentally, the fourth lens L4 and the sixth lens L6 are glass mold lenses, and the seventh lens L7 and the eighth lens L8 are formed of a plastic material. The lenses other than these are assumed to be polished lenses employing a glass material.

Further, in the present example, it is assumed that alignment using the fourth lens is made in the wide-angle end.

### Example 5

All specifications are shown below.

| | |
|---|---|
| f | 4.46-7.31-12.26 |
| F | 3.15-4.24-5.60 |
| Zoom ratio | 2.75 |
| 2Y | 5.712 |

Surface data is shown below.

| | | | | | Effective |
|---|---|---|---|---|---|
| Surface | | | | | Radius |
| Number | R (mm) | D (mm) | Nd | νd | (mm) |
| 1 | 639.785 | 0.400 | 1.88300 | 40.8 | 3.83 |
| 2 | 8.958 | 1.181 | | | 3.48 |
| 3 | ∞ | 5.638 | 1.84670 | 23.8 | 3.38 |
| 4 | ∞ | 0.647 | | | 2.70 |
| 5 | −11.476 | 0.400 | 1.72920 | 54.7 | 2.63 |
| 6 | 20.379 | 0.871 | 1.92290 | 20.9 | 2.61 |
| 7 | −54.636 | d1(variable) | | | 2.58 |
| 8(optical stop) | ∞ | 0.000 | | | 1.84 |
| 9* | 4.174 | 1.428 | 1.69350 | 53.2 | 2.00 |
| 10* | −26.728 | 0.200 | | | 1.98 |
| 11 | 6.453 | 0.400 | 1.90370 | 31.3 | 1.92 |
| 12 | 2.590 | 2.260 | 1.49700 | 81.4 | 1.76 |
| 13* | −131.666 | d2(variable) | | | 1.74 |
| 14* | −22.697 | 0.500 | 1.53050 | 55.7 | 1.71 |
| 15* | 3.671 | d3(variable) | | | 1.72 |
| 16* | 86.644 | 1.863 | 1.53050 | 55.7 | 3.36 |
| 17* | −4.922 | 1.911 | | | 3.14 |
| 18 | ∞ | 0.500 | 1.51680 | 64.2 | 2.94 |
| 19 | ∞ | | | | 2.92 |

Aspherical coefficients are shown below.

Ninth Surface
K = 0.00000E+00, A4 = −0.80636E−03, A6 = −0.98475E−04,
A8 = −0.96060E−05, A10 = 0.29740E−05, A12 = 0.49744E−06
Tenth Surface
K = 0.00000E+00, A4 = 0.14495E−02, A6 = −0.42534E−03,
A8 = 0.13496E−03, A10 = −0.30766E−04, A12 = 0.26415E−05
Thirteenth Surface
K = 0.00000E+00, A4 = 0.35485E−03, A6 = 0.27051E−03,
A8 = 0.13544E−03, A10 = −0.80179E−04, A12 = 0.11369E−04
Fourteenth Surface
K = 0.00000E+00, A4 = 0.64614E−02, A6 = 0.44697E−03,
A8 = −0.13644E−02, A10 = 0.25407E−03
Fifteenth Surface
K = 0.00000E+00, A4 = 0.96015E−02, A6 = 0.32668E−03,
A8 = −0.13886E−02, A10 = 0.25047E−03
Sixteenth Surface
K = 0.00000E+00, A4 = −0.90200E−03, A6 = 0.16311E−03,
A8 = 0.45890E−04, A10 = −0.72724E−05, A12 = 0.47914E−06
A14 = −0.87290E−08
Seventeenth Surface
K = 0.00000E+00, A4 = 0.14212E−02, A6 = −0.86719E−04,
A8 = 0.22770E−04, A10 = 0.53370E−05, A12 = −0.95692E−06
A14 = 0.47861E-07

Data during variable magnification is shown below.

| | Wide-Angle | Intermediate | Telescopic |
|---|---|---|---|
| f | 4.46 | 7.31 | 12.27 |
| F | 3.15 | 4.24 | 5.60 |
| fB | 2.80 | 2.75 | 2.73 |
| 2ω | 67.9 | 42.0 | 25.5 |
| L | 28.51 | 28.46 | 28.44 |
| d1 | 6.656 | 3.549 | 0.500 |
| d2 | 1.503 | 1.899 | 3.431 |
| d3 | 1.591 | 4.302 | 5.820 |

Lens group data is shown below.

| Group | Initial Surface | Focal Length (mm) |
|---|---|---|
| 1 | 1 | −6.69 |
| 2 | 8 | 5.37 |
| 3 | 14 | −5.92 |
| 4 | 16 | 8.84 |

Values corresponding to each conditional expression described above are shown below.

n2n − n2p2 = 0.407
v2p2 − v2n = 50.1
|f1b/fT| = 2.243
v1n − v1p = 33.8
(r12n + r22n)/(r12n − r22n) = 2.341
(r12p2 + r22p2)/(r12p2 − r22p2) = −0.961
f2n2p2/f2p1 = −21.881
|f1a/fW| = 2.308
|f3/fW| = 1.327

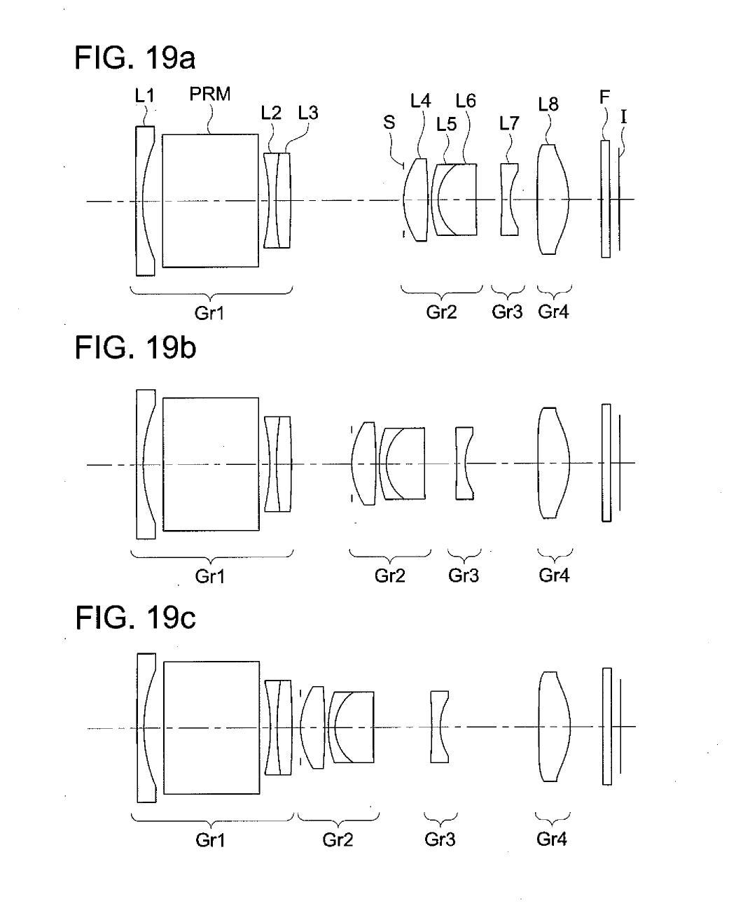

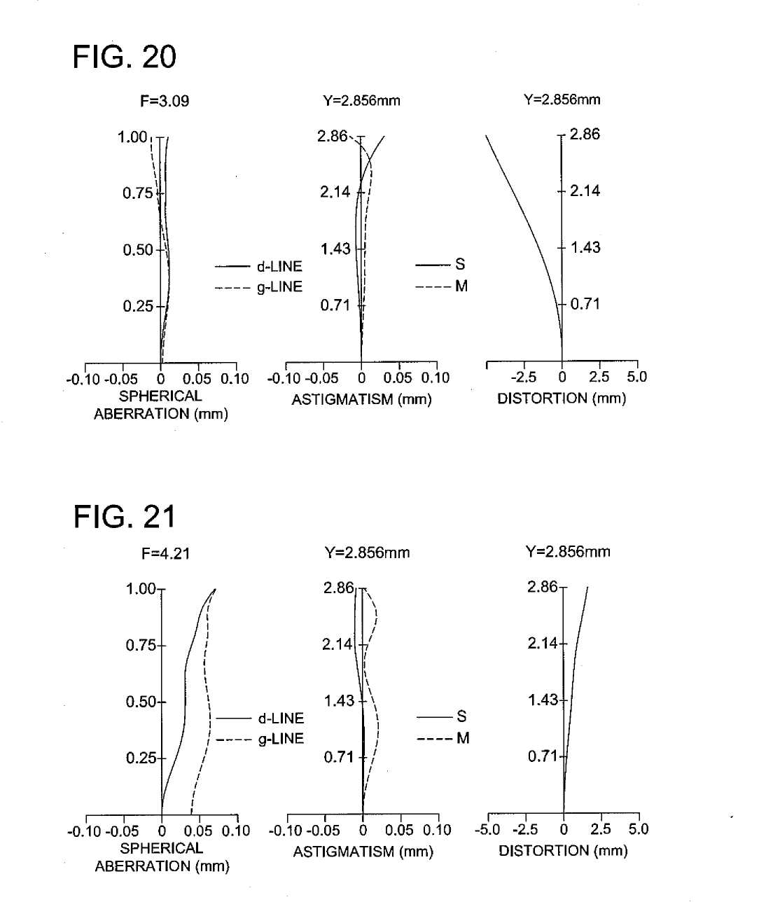

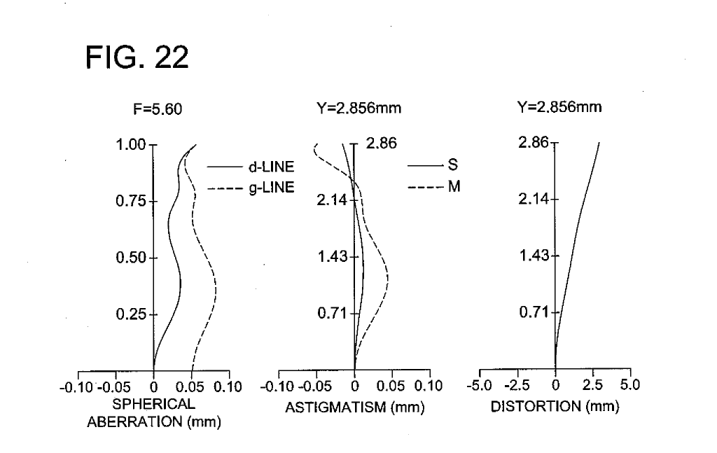

FIG. 19 is a cross-sectional view of a zoom lens. FIG. 19A is a cross-sectional view in the wide-angle end; FIG. 19B is a cross-sectional view in the middle; and FIG. 19C is a cross-sectional view in the telescopic end. FIG. 20 is an aberration figure in the wide-angle end; FIG. 21 is an aberration figure in the intermediate focal length; and FIG. 22 is an aberration figure in the telescopic end.

In the present zoom lens, the second lens group Gr2 moves to the object side in the optical axis direction during variable magnification from the wide-angle end to the telescopic end and the third lens group Gr3 moves to the object side in the optical axis direction to change the distances between the lens groups for variable magnification. The remaining lens groups are fixed during variable magnification. Further, when the third lens group Gr3 is allowed to move, focusing between infinity to finite distance can be carried out. Incidentally, the fourth lens L4 and the sixth lens L6 are glass mold lenses, and the seventh lens L7 and the eighth lens L8 are formed of a plastic material. The lenses other than these are assumed to be polished lenses employing a glass material.

Further, in the present example, it is assumed that alignment using the fourth lens is made in the wide-angle end.

Herein, the refractive index of a plastic material largely varies with changes of temperature. Therefore, when the seventh lens L7 or the eighth lens L8 is formed of a plastic lens, there is produced a problem in which the image point position of the total imaging lens system varies with changes of peripheral temperature.

Therefor, over recent years, it has been found that when inorganic fine particles are mixed in a plastic material, the temperature change of the plastic material can be reduced. For details, generally, when fine particles are mixed in a transparent plastic material, light scattering is generated and then transmittance is decreased, resulting in the difficulty of use as an optical material. However, when the size of fine particles is allowed to be smaller than the wavelength of a transmitted light flux, no scattering can be generated practically. While with temperature elevation, the refractive index of a plastic material decreases, the refractive index of inorganic fine particles increases with temperature elevation. Therefore, when by use of these temperature dependences, these characteristics are allowed to act so as to offset each other, it is possible that refractive index hardly changes. Specifically, when inorganic particles of a maximum length of at most 20 nm are dispersed in a plastic material serving as a base material, a plastic material, in which the temperature dependence of refractive index is extremely low, is realized. For example, when fine particles of niobium oxide (Nb₂O₅) are dispersed in an acrylic resin, the refractive index change with changes of temperature can be minimized. In the present invention, when for the seventh lens L7 or the eighth lens L8, a plastic material in which such inorganic particles are dispersed is used, the image point position variation of the total imaging lens system can be controlled to a small extent during changes of temperature.

Further, over recent years, as a method of mounting imaging devices at reduced coat and in large amounts, there has been proposed a technique in which a substrate where solder has been previously potted is subjected to reflow treatment (heating treatment) with mounted electronic components such as IC chips and optical elements to melt the solder and thereby these electronic components and optical elements are simultaneously mounted on the substrate.

For mounting using such reflow treatment, optical elements need to be heated at about 200-260° together with electronic components. However, at such high temperatures, a lens employing a thermoplastic resin is thermally deformed or changed in color, resulting in the problem of a decrease in its optical performance. As one method to solve such a problem, a technique is proposed in which a glass mold lens featuring excellent heat-resistant performance is used to achieve a good balance between size reduction and optical performance at high temperature, leading, however, to higher cost than that of a lens employing a thermoplastic resin. Thereby, the problem that the demand for cost reduction of imaging elements cannot be met has been produced.

Therefor, an energy curable resin is used as an imaging lens material and thereby compared to a lens employing a thermoplastic resin such as a polycarbonate-based or polyolefin-based resin, the decrease of optical performance is small when exposed to high temperature, resulting in being efficient in reflow treatment and in being easier to produce and more inexpensive than a glass mold lens, whereby the compatibility between const reduction and mass productivity with respect to an imaging device in which an imaging lens is incorporated can be realized. Herein, the energy curable resin is considered to refer to either of a thermally curable resin and a UV curable resin.

1. A zoom lens comprising, in order from an object side thereof:
a first lens group having negative refractive power;
a second lens group having positive refractive power;
a third lens group having negative refractive power; and
a fourth lens group having positive refractive power,
wherein the zoom lens carries out variable magnification by changing distances between the lens groups,
wherein a distance between the first lens group and the second lens group decreases by a variable magnification ranging from a wide-angle end to a telescopic end,
wherein the first lens group contains a reflective optical element functioning to bend a light path by reflecting a light beam,
wherein the second lens group contains a positive 2 p1 lens, a negative 2n lens, and a positive 2p2 lens in order from the object side,
wherein the third lens group contains a single negative lens, and
wherein the zoom lens satisfies the following conditional expressions:
0.30<n2n−n2p2<0.50
and
30<ν2p2−ν2n<60,
where n2n is a refractive index of the 2n lens,
n2p2 is a refractive index of the 2p2 lens,
ν2p2 is an Abbe number of the 2p2 lens, and
ν2n is an Abbe number of the 2n lens

2. The zoom lens described in claim 1, wherein the first lens group has a cemented lens having negative refractive power containing a negative 1n lens and a positive 1p lens on a most image side and the zoom lens satisfies the following conditional expressions:
1.5<|f1b/fT|<4.0
and
30<ν1n−ν1p<50,
where f1b is a composite focal length of the cemented lens on the most image side of the first lens group,
fT is a focal length of a total system at a telescopic end,
ν1n is an Abbe number of the 1n lens, and
ν1p is an Abbe number of the 1p lens.

3. The zoom lens described in claim 1, wherein the second lens group has a cemented lens containing a 2n lens and a 2p2 lens and the zoom lens satisfies the following conditional expressions:
1.6<(r12n+r22n)/(r12n−r22n)<3.0
and
−0.8<(r12p2+r22p2)/(r12p2−r22p2)<−0.4,
where r12n is a paraxial curvature radius of an object side of the 2n lens,
r22n is a paraxial curvature radius of an image side of the 2n lens,
r12p2 is a paraxial curvature radius of an object side of the 2p2 lens, and
r22p2 is a paraxial curvature radius of an image side of the 2p2 lens.

4. The zoom lens described in claim 1, wherein the zoom lens satisfies the following conditional expression:
3.0<f2n2p2/f2p1<10.0,
where f2n2p2 is a composite focal length of the 2n lens and the 2p2 lens, and
f2p1 is a focal length of the 2p1 lens.

5. The Zoom lens described in claim 1, wherein the first lens group contains, on a most object side, a lens having negative refractive power and a meniscus shape whose convex surface faces the object side.

6. The zoom lens described in claim 1, wherein the first lens group contains a lens of negative refractive power on a most object side and the zoom lens satisfies the following conditional expression:
1.0<|f1a/fW|<3.0,
where f1a is a focal length of a lens at the most object side of the first lens group, and
fW is a focal length of a total system at a wide-angle end.

7. The zoom lens described in claim 1, wherein the zoom lens satisfies the following conditional expression:
0.8<|f3/fW|<2.0,
where f3 is a focal length of the third lens group, and
fW is a focal length of a total system at a wide-angle end.

8. The zoom lens described in claim 1, wherein the third lens group is formed of a plastic material and at least one surface is aspherically shaped.

9. The zoom lens described in claim 1, wherein the third lens group moves in an optical axis direction to carry out focusing between infinity to finite distance.

10. The zoom lens described in claim 1, wherein the fourth lens group does not move during variable magnification or focusing.

11. An imaging device provided with a zoom lens described in claim 1.
